(19) United States
(12) Patent Application Publication
(10) Pub. No.: US 2011/0166784 A1
(43) Pub. Date: Jul. 7, 2011

(54) METHODS AND APPARATUS FOR DATA COLLECTION AND REPORTING

(76) Inventors: Peter Tyrrell, Gilbert, AZ (US); Chris Kern, Chandler, AZ (US)

(21) Appl. No.: 12/984,481

(22) Filed: Jan. 4, 2011

Related U.S. Application Data
(60) Provisional application No. 61/292,009, filed on Jan. 4, 2010.

(51) Int. Cl. G01C 21/00

(52) U.S. Cl. 701/213

(57) ABSTRACT

A data reporting and collection system according to various aspects of the present invention is configured to signal a global positioning satellite enabled mobile device to collect data relating to the relative position of the device over a period of time. In one embodiment, the data reporting and collection system comprises a polling system linked and/or embedded with the mobile device. The polling system is adapted to control how the data is collected, saved, and transferred to a reporting system that may be selectively connected to the polling system. The reporting system processes the saved data and converts the data into one or more user reports summarizing the saved data. For example, the reporting system may compile an entire year's worth of mileage data into a tax report that may be submitted with a tax return.

### CROSS-REFERENCES TO RELATED APPLICATIONS

This application claims the benefit of U.S. Provisional Patent Application No. 61/292,009, filed on Jan. 4, 2010, and incorporates the disclosure of that application in its entirety by reference. To the extent that the present disclosure conflicts with any referenced application, however, the present disclosure is to be given priority.

### BACKGROUND OF INVENTION

Accurate tracking of accrued mileage and time spent commuting between destinations is an important metric for many businesses and professionals. This is especially true with dual use vehicles that may be used for both business and personal endeavors. The traditional method of tracking accrued mileage and time spent driving has been a manual procedure that is both cumbersome and potentially inaccurate. New methods of tracking mileage and time use satellites and other related global positioning systems to accurately track a vehicle's movement. These methods and systems, however, may not automatically track the information that is important to a particular user or they may not be able to output the collected data without the use of complex and expensive equipment that may have to be installed within a vehicle.

### SUMMARY OF THE INVENTION

A data reporting and collection system according to various aspects of the present invention is configured to signal a global positioning satellite enabled mobile device to collect data relating to the reative position of the device over a period of time. In one embodiment, the data reporting and collection system comprises a polling system linked and/or embedded with the mobile device. The polling system is adapted to control how the data is collected, saved, and transferred to a reporting system that may be selectively connected to the polling system. The reporting system processes the saved data and converts the data into one or more user reports summarizing the saved data. For example, the reporting system may compile an entire year's worth of mileage data into a tax report that may be submitted with a tax return.

### BRIEF DESCRIPTION OF THE DRAWINGS

A more complete understanding of the present invention may be derived by referring to the detailed description when considered in connection with the following illustrative figures. In the following figures, like reference numbers refer to similar elements and steps throughout the figures.

FIG. 1 representatively illustrates connection of a portable electronic device and a secondary computer in accordance with an exemplary embodiment of the invention; and

FIG. 2 is a flow chart representatively illustrating a method of data collecting and reporting.

### DETAILED DESCRIPTION OF EXEMPLARY EMBODIMENTS

The present invention may be described in terms of functional block components and various processing steps. Such functional blocks may be realized by any number of components configured to perform the specified functions and achieve the various results. For example, the present invention may employ various portable electronic devices, computers, sensors, and the like, which may carry out a variety of functions. In addition, the present invention may be practiced in conjunction with any number of portable devices such as handheld global positioning satellite (GPS) systems, mobile telephones, and other wired or wireless devices, and the system described is merely one exemplary application for the invention. Further, the present invention may employ any number of conventional techniques for receiving and processing positioning information from satellites, cellular towers, radio transmitting stations, and the like.

Methods and apparatus for data collection and reporting according to various aspects of the present invention may operate in conjunction with any suitable mobile and/or stationary device. Various representative implementations of the present invention may be applied to any system for receiving and processing signals relating to positioning data. Certain representative implementations may include, for example, a GPS enabled mobile communication device, a handheld portable GPS unit, or an automobile in-dash navigation unit.

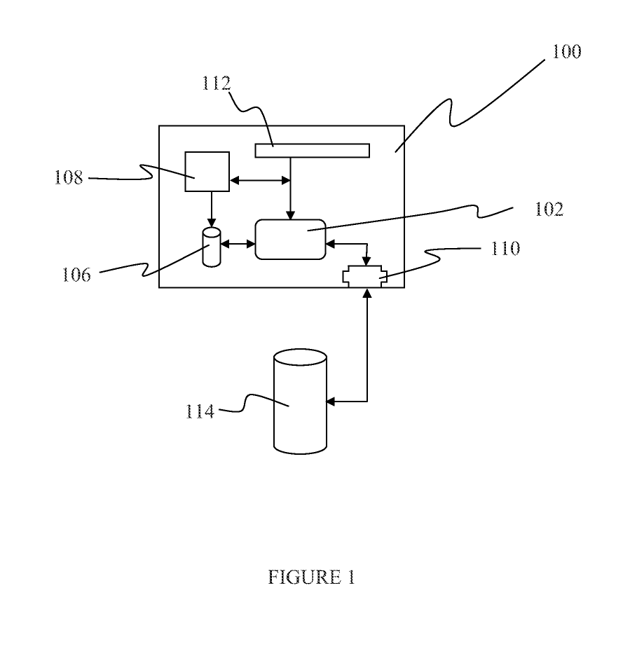

Referring to FIG. 1, in one embodiment, methods and apparatus for a data collection and reporting system may comprise a mobile device 100 suitably adapted to receive and process GPS information. The mobile device 100 may be configured with a GPS receiver 112, a computer processor 102, a memory device 106, and an input/output device 110. The mobile device 100 may also be suitably adapted to execute commands from a secondary system such as a polling system 108.

The mobile device 100 receives data and/or information from at least one external source. The mobile device 100 may comprise any suitable system configured to receive and process information from sources such as satellites, cellular towers, radio broadcasting stations, wireless hot spots, the internet, and the like. For example, in one embodiment, the mobile device 100 may comprise a handheld portable GPS navigation device. In another embodiment, the mobile device 100 may comprise a GPS enabled mobile telephone, or “smartphone” adapted to operate on any wireless communication platform or service provider. In a third embodiment, the mobile device 100 may comprise a GPS enabled personal computing device. Alternatively, the mobile device 100 may be permanently or semi-permanently installed within a vehicle, such as an in-dash navigation unit.

The mobile device 100 may operate in any suitable manner and receive data either wirelessly or via a wired connection to a separate receiving device such as an antenna. The processor 102 may control one or more functions of the mobile device 100 and may comprise any suitable device, such as a typical central processing unit found in mobile electronic devices.

The memory device 106 stores information that is either received, generated, or calculated by the mobile device 100. The memory device 106 may comprise any suitable memory system such as a hard disc drive, flash memory, removable media card, or some combination of multiple types of memory. The memory device 106 may be configured to either permanently or temporarily store data in response to a command from the processor 102 and/or a polling system 108. The memory device 106 may also be accessed by external sources such as through USB connection to the mobile device 100. Alternatively, the mobile device 100 may be configured to transmit data from the memory device 106 through a wireless signal and/or upload saved data through an internet connection.

The mobile device 100 may also be configured with at least one input/output device 110 that is suitably configured to transfer data between the mobile device 100 and an external system. The input/output device 110 may comprise any of a standard type of electrical connectors such as a USB port, a serial port, a parallel port, an infrared transceiver, a memory card reader/interface, and the like either now known or otherwise. The input/output device 110 may also be configured to transmit data wirelessly such as via connection to a wireless internet or local area network router, mobile communication system, and the like.

The polling system 108 signals the mobile device 100 to begin collecting a set of data corresponding to the movement of the data receiver over a period of time. The polling system 108 may comprise any suitable system for communicating with the mobile device 100. For example, in one embodiment, the polling system 108 may comprise a secondary application adapted to run on the data receiver using the local processor 102, memory device 106, and/or operating system of the mobile device 100. The polling system 108 may be configured to be installed or otherwise embedded with the mobile device 100, saved to the memory device 106, and then accessed as an application resident on the mobile device 100. Alternatively, the polling system 108 may reside on a computer readable media such as a flash drive or a non-volatile memory card and be suitably configured to be connected to the mobile device 100 through one of the input/output devices 110 and accessed by the processor 102 as necessary. In yet another embodiment, the polling system may operate on a device configured to connect to or access the mobile device 100.

The polling system 108 may also be configured to signal the mobile device 100 to capture data in any suitable fashion. The polling system 108 may signal the mobile device 100 to save a continuously streaming set of data over a period of time or it may periodically receive data. For example, in one embodiment, the polling system may be configured to receive a continuous feed of data from the antenna 112 comprising information such as GPS coordinates, time, and instantaneous vehicle speed. This data may be formatted in a particular format and saved to a unique file on the memory device 106 for later use and/or processing. In another embodiment, the polling system 108 may be configured to poll to mobile device 100 for information such as GPS coordinates, time, and average vehicle speed at predetermined or selected intervals such as every few seconds, minutes, or hours. In another embodiment, the polling system 108 may poll the mobile device 100 for GPS data based upon a selectable time period increment. The polling system 108 may also be suitably configured to save the data on the same computer readable media that houses the polling system.

The polling system 108 may also comprise a graphic user interface (GUI) that is presented to a user as a way of requesting user specific information. The GUI may be presented to the user via the same display device as is used by the mobile device 100. For example, a user may be presented with a data entry template on the screen of the mobile device 100 which requests user specific information from the user such as purpose and/or type of trip, starting destination, end destination, which car is being used, the category or client that the trip was made for, intermediate way points, a current odometer reading, additions of fuel, tolls paid, and/or a polling period increment. In one embodiment, the polling system 108 may simply present the user with an interface for activating and deactivating the polling system 108 data capture. In another embodiment, the polling system 108 may present the user with a predetermined set of selectable criteria or manual data entry fields.

The polling system 108 may save the collected data from the data receiver 102 in any suitable manner. For example, data may be appended to a single file or it may be saved to individual files for each trip or trip segment. Alternatively, collected data may be saved and organized by user, vehicle, type of trip, date range, or any other suitable method. Collected data may also be transferred and saved to a database which is suitably configured to house collected data from multiple data receivers. For example, the database may be centrally located within the central or regional office that oversees the operation of a fleet of vehicles.

The polling system 108 may also be suitably adapted to transfer the collected data to another application, computer readable media, database, or another device. For example, the polling system 108 may be configured to transfer data saved from the memory device 106 of the mobile device 100 to a separate device such as an external database 114 via the input/output device 110. This transfer may occur through a wired connection to a computer or the information may be emailed to the computer by any suitable method and then saved to the external database 114. In another embodiment, the polling system 108 may also be configured to transfer data via a wireless connection resident on the mobile device 100. In yet another embodiment, the polling system may be directly connected to a separate device, such as through a memory card reader, and transfer the collected data directly to the separate device.

The reporting system processes the collected data and converts it into any of a plurality of useful reports. The reporting system may process the collected data by any suitable method and may do so before or after the collected data is initially saved. For example, in one embodiment, the reporting system may use information entered by the user at the data entry screen to set a group of parameters for how the collected data will be processed. As the data is generated by the mobile device 100 and collected by the polling system 108, the reporting system may process the data by the appropriate algorithms and format the results into a format for saving on the memory device 106.

Alternatively, the reporting system may be initiated by the user after the raw data collected from the mobile device 100 has been transferred to another system and/or device. The reporting system may process and format the data into reports based on any number of suitable criteria, For example, a single annual report may be created from data for a given vehicle from amongst a plurality of vehicle data contained within a database. This report may be customized for any suitable purpose, such as, for example to assist in the preparation of internal revenue service (IRS) forms to calculate the proper mileage reduction. The reporting system may also be configured to replicate the appropriate IRS form and automatically populate the fields with the appropriate data.

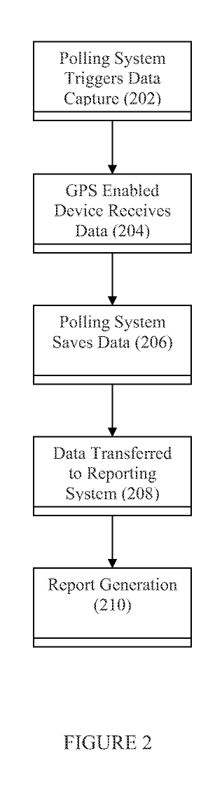

Referring now to FIG. 2, in operation, a user connects a polling system 108 to a portable mobile device 100 such as a handheld GPS enabled device. The user may then activate the polling system 108 via a user interface of the mobile device 100 and signal the mobile device 100 to begin capturing GPS data (202). The user may be prompted to enter criteria pertaining to a particular use, such as vehicle identification information, starting and ending points, intermediate waypoints, fuel level or amount of fuel added, and/or an odometer reading from the vehicle. Alternatively, the user may simply be presented with an activation and/or deactivation button to activate the polling system 108.

After activating the polling system 108, the user may then begin operating the vehicle, for example starting a delivery route. As the vehicles moves and the mobile device 100 receives GPS data (204), the polling system 108 captures the collected data and saves the information by any suitable method (206). For example, the polling system 108 may make use of an onboard memory device 106 that is resident to the mobile device 100. Alternatively, the polling system 108 may save the data to a removable memory media that is connected to the data receiver through an input/output device 110.

When the user arrives at either the end point or an intermediate point, he may communicate with the polling system 108 through any suitable method so as to designate that a point of interest has been arrived at for data logging purposes. Alternatively, the polling system 108 may automatically recognize that a point of interest has been reached by comparing the current GPS coordinates to a location entered by the user before the data tracking commenced.

Collected data may then be transferred to a separate device and/or system, such as a database, where the information may be stored for later processing (208). The collected data may then be processed and/or analyzed for any suitable purpose by a reporting system (210). For example, the reporting system may prepare a report summarizing the total mileage traveled by a vehicle over the course of the day's worth of deliveries. Alternatively, the reporting system may prepare a tax report totaling the mileage for a fleet of vehicles over an entire year.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing description, the invention has been described with reference to specific exemplary embodiments. Various modifications and changes may be made, however, without departing from the scope of the present invention as set forth. The description and figures are to be regarded in an illustrative manner, rather than a restrictive one and all such modifications are intended to be included within the scope of the present invention. Accordingly, the scope of the invention should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present invention and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

The present invention has been described above with reference to an exemplary embodiment. However, changes and modifications may be made to the exemplary embodiment without departing from the scope of the present invention. These and other changes or modifications are intended to be included within the scope of the present invention.

1. A non-transitory computer readable medium containing instructions for a computer and a mobile device having a Global Positioning System (GPS) receiver, a processor, and a memory device, wherein the computer and mobile device are selectively linked together and the instructions cause:
the processor to save user specific data to the memory device;
the processor to save GPS data generated by the GPS receiver to the memory device in response to a command from a polling system coupled to the mobile device;
the mobile device to transfer the saved GPS data from the memory device to a reporting system coupled to the computer; and
the computer to process the saved GPS data into a user report.

2. A non-transitory computer readable medium according to claim 1, further comprising polling the GPS receiver for GPS data by at least one of a selectable time increment and real-time data streaming.

3. A non-transitory computer readable medium according to claim 1, wherein transferring the saved user specific and GPS data to the computer comprises transmitting the data wirelessly.

4. A non-transitory computer readable medium according to claim 1, further comprising presenting a user interface on a display of the mobile device.

5. A non-transitory computer readable medium according to claim 4, wherein the user interface comprises:
a data entry field corresponding to the user specific data;
a data entry field corresponding to a type of GPS data to be saved; and
a command button adapted to signal the polling system when to begin and end saving GPS data.

6. A non-transitory computer readable medium according to claim 1, wherein the memory device comprises a removable computer readable medium.

7. A non-transitory computer readable medium according to claim 1, further comprising managing the saved user specific and GPS data for multiple users and mobile devices.

8. A non-transitory computer readable medium according to claim 1, wherein the user report comprises at least one of a completed tax form, an expense report, and a mileage tracking log.

9. A computer-implemented system for managing data received from a Global Positioning System (GPS) enabled mobile device having a GPS receiver, a processor, and a memory device, comprising:
a polling system linked to the GPS enabled mobile device and configured to:
save user specific data to the memory device; and
selectively cause the processor to save GPS data received by the GPS receiver to the memory device; and
a reporting system selectively linked to the memory device and configured to:
receive the saved user specific and GPS data from the memory device; and
process the user specific and GPS data into a report.

10. A computer-implemented system according to claim 9, wherein the polling system is embedded with the GPS enabled mobile device.

11. A computer-implemented system according to claim 9, wherein the polling system is further configured to set a time increment between a set of data points for the saved GPS data.

12. A computer-implemented system according to claim 9, further comprising a user interface presented on a display of the GPS enabled mobile device.

13. A computer-implemented system according to claim 9, wherein the user interface comprises:
a data entry field corresponding to the user specific data;
a data entry field corresponding to a type of GPS data to be saved; and
a command button adapted to signal the polling system when to begin and end saving GPS data.

14. A non-transitory computer readable medium according to claim 9, wherein the reporting system is configured to receive the saved user specific and GPS data from the GPS enabled mobile device wirelessly.

15. A computer-implemented system according to claim 9, wherein the reporting system comprises a database configured to be coupled to a computer system and adapted to manage GPS data for multiple GPS enabled mobile devices.

16. A computer-implemented system according to claim 9, wherein the user report comprises at least one of a completed tax form, an expense report, and a mileage tracking log.

17. A computer-implemented method for collecting and reporting travel information collected by a Global Positioning System (GPS) enabled mobile device having a GPS receiver, a processor, and a memory device, comprising:
coupling a polling system to the GPS enabled mobile device;
communicating a first signal generated by a polling system to the processor, wherein the first signal causes the processor to start saving UPS data received by the receiver to the memory device;
communicating a second signal generated by the polling system to the processor, wherein the second signal causes the processor to stop saving GPS data;
transferring the saved GPS data to a reporting system coupled to a computer system; and
processing the saved GPS data into a report based upon the collected GPS data and a predetermined set of criteria.

18. A method according to claim 17, further comprising presenting a user interface coupled to the polling system and adapted to:
save a set of user specific data to the memory device;
receive instructions relating to a type of GPS data to be saved to the memory device;
initiate the generation of the first and second signal; and
initiate the transfer of the stored GPS data to the reporting system.

19. A method according to claim 17, wherein transferring the saved GPS data to the reporting system comprises transmitting the set of user specific data and GPS data wirelessly.

20. A method according to claim 17, further comprising providing the report as at least one of a completed tax form, an expense report, and a mileage tracking log.
